(19) United States
(12) Patent Application Publication
(10) Pub. No.: US 2025/0186993 A1
(43) Pub. Date: Jun. 12, 2025

(54) SAMPLING WICK

(71) Applicant: Readygo Diagnostics Limited, Bath (GB)

(72) Inventor: Ben Cobb, Bath (GB)

(21) Appl. No.: 18/844,843

(22) PCT Filed: Mar. 8, 2023
(86) PCT No.: PCT/EP2023/055922

§ 371 Date: Sep. 6, 2024

(30) Foreign Application Priority Data
Mar. 8, 2022 (GB) 2203173.6

(51) Int. Cl. B01L 3/00

(52) U.S. Cl. CPC B01L 3/5023; B01L 2200/12; B01L 2200/16; B01L 2300/12

(57) ABSTRACT

A process for producing a sampling device for use in analysis of biological samples is described, the process comprising adsorbing and drying a liquid reaction mix into an elongate porous matrix, and dividing the porous matrix into regular sections.

### FIELD OF THE INVENTION

The present invention relates to a method for producing a sampling device for analysis of biological samples.

### BACKGROUND TO THE INVENTION

Nucleic acid amplification diagnostic tests are in common use around the world, particularly so in view of the SARS-CoV-2 pandemic which has led to the growth of polymerase chain reaction (PCR) tests as the gold standard for diagnosing infection. However, PCR tests have a number of drawbacks, and other diagnostic techniques are being explored, including isothermal amplification methods which have the advantage of not requiring thermal cycling and in some instances can be performed at room temperature.

Such isothermal amplification methods require provision of suitable reagents, such as enzymes and reaction mixes, and this too can pose problems with storage and supply of said reagents. If provided in wet form, these may require temperature controlled storage, while if provided in dried form, reconstitution with an accurately-measured volume of water may be required.

Further, accurate and precise measurement of sample volumes can also be required for implementing typical isothermal amplification assays.

One approach which has been used to such diagnostic assays is provision of lyophilised reagents on an absorbent matrix; wet sample—for instance, blood or saliva—can be delivered to the matrix, which will rehydrate and reconstitute the lyophilised reagents. Again however this can require accurate measurement of sample volume to ensure the reagents are reconstituted at the correct concentrations.

It would be beneficial to provide alternative materials for use in diagnostic assays, particularly (but not exclusively) isothermal amplification of nucleic acids; as well as to provide methods for manufacture of such materials.

### SUMMARY OF THE INVENTION

The present invention addresses these needs, at least in part, by providing a method for producing a sampling device for analysis of biological samples, the device being formed of a porous matrix and comprising dried reagents for performing said analysis. The inventor has surprisingly determined that such a process can provide dried reagents which are entirely compatible with downstream assays and analysis, including isothermal nucleic acid amplification assays.

In a first aspect, there is provided a process for producing a sampling device for use in analysis of biological samples, the process comprising:
a) providing a porous matrix having a regular cross section and a generally elongate form;
b) contacting the matrix with a liquid reaction mix, such that the reaction mix is adsorbed into the matrix;
c) drying the adsorbed liquid reaction mix, to provide a porous matrix having dried reaction mix therein; and
d) dividing the porous matrix into one or more sections of predetermined length; to thereby provide said sampling device.

In use, the sampling device may be contacted with a biological sample—either a liquid sample (for example, blood, saliva, serum, sputum, urine) or a dried sample which has been rehydrated with a suitable liquid (for example, water, reaction buffer or the like). Due to the porous nature of the matrix, the sample will be adsorbed into the matrix and will rehydrate the dried reaction mix, to allow the relevant assay (for example, isothermal amplification) to be carried out within the matrix. While typically the device may be introduced to the sample by, for example, dipping or immersing the device into a liquid sample, in some embodiments the sample may be introduced to the device (for example, by placing or dispensing a previously-obtained sample onto the device). Further, the device may be left in place for the subsequent reaction and assay, or may be transported into a separate location for this (for example, loaded into an assay reading device).

The step of dividing the porous matrix into sections may comprise cutting the porous matrix into individual sections. In some embodiments, however, the sections may remain physically connected after dividing, but are not fluidically connected. In particular, where the matrix is a polymeric material, the dividing step may take the form of crimping a continuous matrix into sections; optionally while applying heat to fuse polymers in the crimped zones. Such a process can be carried out for a time short enough and at a temperature low enough so as not to denature the relevant enzymes in the matrix.

This manufacturing process has a number of advantages and benefits, as will be seen from the description herein. One key advantage is that the process allows for continuous manufacturing—an elongate matrix may be passed sequentially through a reaction mix and a drying station to a cutting station where sections may be cut in step d); this can provide multiple sampling devices in a relatively short time.

A further advantage comes from cutting or otherwise dividing the sections of porous matrix into lengths. Since the matrix has a regular cross section, then the volume of the cut section per unit length will be defined; this, combined with known properties such as void volume and air space of the matrix, means that a consistent volume of liquid will be taken up by each cut section. This in turn results in the key advantages that the volume of both the reaction mix absorbed into the matrix and dried, and the volume of sample taken up by the same section will be matched; such that the concentration of reaction mix can be controlled in order to achieve optimum dilution by the sample to carry out the desired reaction.

The matrix is preferably a fibrous matrix, comprising a plurality of bonded fibres which define voids therebetween. The fibrous matrix may be an extruded fibrous matrix. The fibres in the matrix are preferably aligned with one another, to define a longitudinal axis—this is in general the same axis as the long axis of the elongated matrix. The fibres may be a polymer material, and are preferably polyolefins (including LDPE, LLDPE, HDPE, PP); polyesters (including PET, PTT, PBT); or polyamides. Most preferred polymers are polyethylene or polypropylene. In embodiments the pore size of the matrix is between 10-100 um, and the pore volume is 50-95%. Suitable materials include those manufactured by Porex Corporation, Georgia, USA.

A particularly preferred matrix is described in US 2005/0189292, the contents of which are incorporated herein by reference. Specifically, this matrix comprises a self-sustaining, fluid transmissive body comprising a plurality of bundled, crimped, bicomponent fibres bonded to each other at spaced apart contact points, each bicomponent fibre having a fibre structure comprising a first fibre component formed from a polyamide material and a second fibre component, the fibres collectively defining tortuous fluid flow paths through the fluid transmissive body. An additional benefit of the use of extruded fibrous matrices is that the resulting matrix typically provides a “core” and “sheath” arrangement, in which the matrix is typically denser around the circumference, and less dense in the centre; this can help to reduce sample fluid loss through the circumferential edges of the cut device and encourage sample fluid flow into and along the device from the cut faces; as well as reducing dried reagent mix loss during handling and transport. A preferred composition for such a matrix for use in the present invention is a polyethylene core and a polypropylene sheath. Use of polypropylene is particularly advantageous as it does not bind proteins; meaning that reagents can be dried down onto the matrix and rehydrated without the risk of significant loss through binding to the matrix. In some embodiments, the reagents may additionally comprise bovine serum albumin (BSA), which has been shown to further reduce nonspecific protein binding to matrices.

Natural fibres with potential to lower environmental impact such as cellulose and lignin might also be considered. See, for example, the materials discussed in “A review on natural fibers for development of eco-friendly bio-composite: characteristics, and utilizations”, Karimah et al, Journal of Materials Research and Technology, Volume 13, July-August 2021, Pages 2442-2458.

The reaction mix may be for any suitable assay, but is preferably for a nucleic acid amplification based assay. This may include isothermal nucleic acid amplification based assays, including nucleic acid sequence-based amplification (NASBA), loop-mediated isothermal amplification (LAMP), helicase-dependent amplification (HDA), rolling circle amplification (RCA), multiple displacement amplification (MDA), recombinase polymerase amplification (RPA), lesion-induced DNA amplification (LIDA), as well as RT- versions of these. The reaction mix will typically include appropriate nucleotides, enzymes, primers and probes, as well as buffers, cations, and so on. The skilled person will be aware of what components are necessary for a given assay.

In some embodiments, the reaction mix is for a thermal cycling assay, such as conventional PCR methods including but not limited to PCR, RT-PCR, LATE-PCR as well as convective PCR (cPCR) and capillary loop convective PCR (clcPCR). The concept of convection has been used for DNA amplification based on PCR. A high surface to area ratio cylinder and two heating zones set to denature (95° C.) and annealing (50-70) cause movement of the amplification via the phenomenon of Rayleigh-Bénard convection to create a steady flow and circulation within the temperature field. Therefore, without heating and cooling the container repeatedly, reagents circulate spontaneously and then experience three amplification processes.

This technique has further been modified to allow for capillary loop convective polymerase chain reaction (clcPCR) to improve the amplification efficiency. It is thought improve efficiency by generating a directional flow. This uses U-shaped loop glass capillaries with 1.6 mm inner diameter. The clcPCR platform utilizes one isothermal heater for heating the bottom of the loop capillary.

In embodiments the reaction mix further comprises a cryoprotective sugar to protect proteins against effects of drying. Typical sugars for this purpose include disaccharides such as maltose, sucrose, and preferably trehalose. Alternatively, the cryoprotective sugar may be a high molecular weight sugar, for instance, dextran. In some embodiments, combinations of sugars and/or other cryoprotectants may be present, for example, trehalose and dextran.

In embodiments the concentration of the reaction mix prior to drying is preferably at 1× concentration. This means that, after rehydration with a liquid sample at the predetermined volume taken up by the device, the reconstituted reaction mix is at the correct concentration to carry out the assay.

The reaction mix preferably comprises a fluorophore or a chromophore to allow visual detection of the products of the reaction.

The step of contacting the fibrous matrix with the liquid reaction mix may comprise immersing a portion of the matrix in the reaction mix. Alternatively the step may comprise spraying a portion of the matrix with the reaction mix. In either case, the method may comprise allowing the immersed or sprayed portion to become saturated with the liquid mix; again this maintains consistency between separate devices.

The method may further comprise the step of covering the circumferential edge of the matrix with a non-permeable coating. This may be carried out before or after cutting the matrix at step d). The non-permeable coating may be useful to reduce sample fluid loss through the circumferential edges of the cut device and encourage sample fluid flow into and along the device from the cut faces; as well as reducing dried reagent mix loss during handling and transport. The coating may be, for example, a polymer wrap, spray or the like; or an extruded polymer tube; or so on. Alternatively, as noted above, the matrix may be manufactured in such a way as to have a denser sheath formed around the edge of a less dense core.

In some embodiments, the method may further comprise the step of assembling a plurality of sampling devices such that they are in fluidic contact. This allows fluid to flow from a first to a second sampling device, and may permit different reaction mixes to be included in each device. For example, a first device may have been prepared to include a reaction mix for pretreating a sample; eg, to remove contaminants and/or to lyse cells to release nucleic acids. A second device in fluidic contact with the first can then receive the pretreated sample and carry out, for example, a nucleic acid amplification reaction. In some embodiments, a yet further device may include reagents for detecting reaction products, eg, amplified nucleic acids. This assembly step may comprise enclosing multiple devices in a laminate structure.

In some embodiments, the method may further comprise the step of assembling a plurality of devices such that they are in physical contact, but not in fluidic contact. This allows for parallel processing of multiple samples to increase throughput. For example, multiple cut devices can be grouped together in the same orientation, such that the cut surface—which receives sampl—is exposed. Sample can then be applied to all devices simultaneously. This assembly step may comprise enclosing multiple devices in a laminate structure.

A further aspect of the invention provides a sampling device for analysis of biological samples, the device comprising a section of porous matrix having a regular cross section and a generally elongate form, the matrix comprising a dried reaction mix therein, the reaction mix comprising reagents for analysis of a biological sample.

The section may be physically and fluidically separate from other such sections; or may be fluidically separate but physically connected. In some embodiments, the device comprises a plurality of said sections which are fluidically separated. In other embodiments, the device comprises a plurality of said sections which are fluidically connected. Each of said sections may comprise the same or different dried reaction mixes therein.

The matrix is preferably a fibrous matrix, comprising a plurality of bonded fibres which define voids therebetween. The fibrous matrix may be an extruded fibrous matrix. The fibres in the matrix are preferably aligned with one another, to define a longitudinal axis—this is in general the same axis as the long axis of the elongated matrix. The fibres may be a polymer material, and are preferably polyolefins (including LDPE, LLDPE, HDPE, PP); polyesters (including PET, PTT, PBT); or polyamides. Most preferred polymers are polyethylene or polypropylene. In embodiments the pore size of the matrix is between 10-100 um, and the pore volume is 50-95%. Suitable materials include those manufactured by Porex Corporation, Georgia, USA.

A particularly preferred matrix is described in US 2005/0189292, the contents of which are incorporated herein by reference. Specifically, this matrix comprises a self-sustaining, fluid transmissive body comprising a plurality of bundled, crimped, bicomponent fibres bonded to each other at spaced apart contact points, each bicomponent fibre having a fibre structure comprising a first fibre component formed from a polyamide material and a second fibre component, the fibres collectively defining tortuous fluid flow paths through the fluid transmissive body. A preferred composition for such a matrix for use in the present invention is a polyethylene core and a polypropylene sheath. In some embodiments, the reagents may additionally comprise bovine serum albumin (BSA).

The reaction mix may be for any suitable assay, but is preferably for a nucleic acid amplification based assay. This may include isothermal nucleic acid amplification based assays, including nucleic acid sequence-based amplification (NASBA), loop-mediated isothermal amplification (LAMP), helicase-dependent amplification (HDA), rolling circle amplification (RCA), multiple displacement amplification (MDA), recombinase polymerase amplification (RPA), lesion-induced DNA amplification (LIDA), as well as RT- versions of these. The reaction mix will typically include appropriate nucleotides, enzymes, primers and probes, as well as buffers, cations, and so on. The skilled person will be aware of what components are necessary for a given assay.

In some embodiments, the reaction mix is for a thermal cycling assay, such as conventional PCR methods including but not limited to PCR, RT-PCR, LATE-PCR as well as convective PCR (cPCR) and capillary loop convective PCR (clcPCR).

In embodiments the reaction mix further comprises a cryoprotective sugar to protect proteins against effects of drying. Typical sugars for this purpose include disaccharides such as maltose, sucrose, and preferably trehalose. Dextran may also or alternatively be present.

In embodiments the concentration of the reaction mix prior to drying is preferably at 1× concentration.

The reaction mix preferably comprises a fluorophore or a chromophore to allow visual detection of the products of the reaction.

On contact with a liquid sample, the sample is drawn into the device via capillary action to a predetermined volume required to rehydrate the reaction mix at a concentration suitable for carrying out said reaction.

In embodiments, the porous matrix acts as an optical guide to channel and direct visual signal from a reaction; inclusion of a sugar, preferably trehalose, which matches the refractive index of the porous matrix can also improve the optical guide properties.

In some embodiments, the porous matrix comprises one or more crowding agents or cosolvents used to mimic the macromolecular environment to improve local reaction kinetics. That is, the crowding agent or mimic, potentially together with the geometry of the matrix, can ensure that reagents are brought together and the reaction may proceed in an accelerated manner as compared with the reaction in the absence of said agent or mimic. One such crowding agent mimic is believed to be trehalose.

A further aspect of the invention provides a method of enhancing reaction kinetics in a diagnostic reaction, the method comprising performing the diagnostic reaction within a porous matrix in the presence of a crowding agent or cosolvents used to mimic the macromolecular crowding environment, such that the reaction is accelerated compared with the same diagnostic reaction when carried out in a liquid in the absence of said crowding agent or crowding agent mimic.

### BRIEF DESCRIPTION OF THE DRAWINGS

These and other aspects of the invention will now be described with reference to the accompanying drawings, in which:

FIG. 1 shows an illustration of the production process for the device

FIG. 2 illustrates cutting and crimping of the porous matrix

FIG. 3 shows use of a crimped device with separate regions for different reactions

FIG. 4 shows an arrangement whereby lysis is separates from detection

FIG. 5 shows a plurality of stacked devices

FIG. 6 shows use of a device in a holder

FIG. 7 illustrates further views of a device in a holder

FIG. 8 shows the effect of incorporating trehalose in a test RT-LAMP amplification reaction

FIG. 9 shows the use of the wicks as light guides to direct fluorescent signal

### DETAILED DESCRIPTION OF THE DRAWINGS

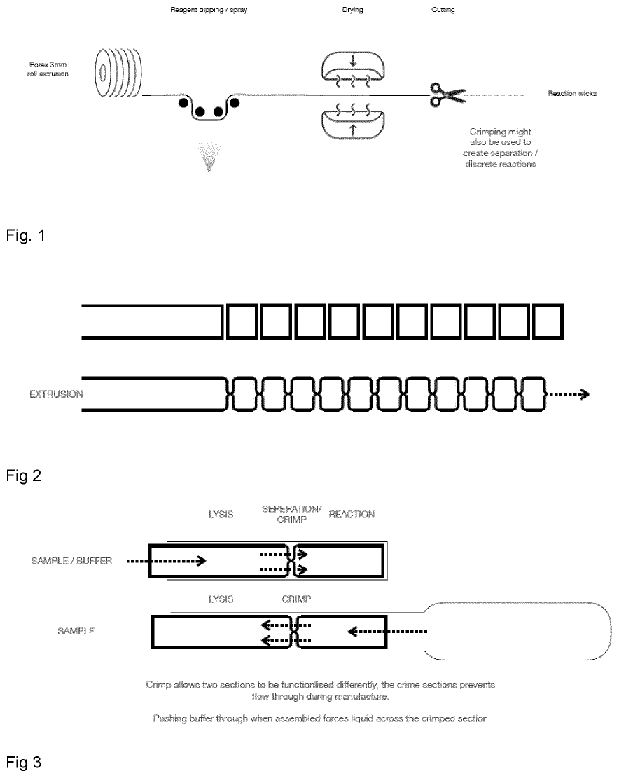

Lyophilisation (freeze drying) is a low temperature dehydration process that involves freezing the product and using vacuum to remove ice through sublimation; while useful for producing dried reagents, it can be complex to implement. In development of sample wicks for conducting biological assays, the present inventor determined that a more straightforward dehydration approach using heat to evaporate water was possible and which yielded sample wicks containing dried reagents which could be used for nucleic acid amplification and detection methods. This simple approach offers a route to a very simple continuous in-line manufacturing process, which is illustrated in FIG. 1.

As shown, the process begins with a continuous roll of porous matrix—in this case, 3 mm diameter Porex® extruded fibrous polypropylene matrix. This is unreeled and passes through a spray station which saturates the section of the wick passing through the spray with a 1× concentration liquid reagent solution. The particular reagent solution selected will depend on the assay to be performed. After saturation, the wick passes through a drying station, which gently heats the wick to evaporate the liquid, leaving dried reagents. After this the wick is either cut into individual pieces, or crimped using heat to isolate the continuous wick into multiple joined sections. See also FIG. 2.

While relatively straightforward, this process offers a number of surprising advantages for the subsequent use of the wicks in sampling and analysis. The process provides an extreme volume dry down continuous real process. Further, the high volume to surface are ratio allows dry down of 1× reaction mix rather than higher concentration stocks that are generally dried down or lyophilised due to thermal stresses; consequently this can avoid the often-seen compromises in kinetics when high concentration buffers (eg. 10×) are used because of rehydration and mixing requirements which can be slow in capillary formats.

The process also removes the need for accurate pipetting on the production line. This is particularly important when pipetting concentrated stocks where volume inaccuracies become important in maintaining final concentrations. Further, there is no need for high concentration enzyme stocks lowering the problems associated with glycerol which can be problematic.

A key advantage though is that reagent wicks can be cut to length and these become discrete and self-regulating components, this also removes the need for accurate pipetting of sample. Instead sample is drawn into the wick via capillary action to the exact volume required to fill the wick and rehydrate the reagents, since the wick can only draw a set volume defined by its geometry which has also taken the correct volume of reaction buffer. Thus, the wick becomes its own premeasured sample and reagent container. Since the dried reagent is within the fibrous matrix, there are no problems with reagent dislodging during transport.

To use the wick, it can be contacted with a liquid sample. Adding sample rehydrates the reagents in the wick, and (as with the reagent fill) since the wick only takes up a defined volume defined by its geometry, this completely removes the need for accurate pipetting. By allowing overflow of excess sample, once the wick becomes saturated with buffer (or water, or sample) excess is not absorbed; this can be used to accommodate variability in buffer volume delivery. In addition, since the wick fills from either or both ends to become saturated, there is no required orientation for the assay to work or for the fill to be directional. In some embodiments, the wick may be immersed in or contacted with a sample; in other embodiments, a sample may be placed onto or adjacent to the wick to allow absorption.

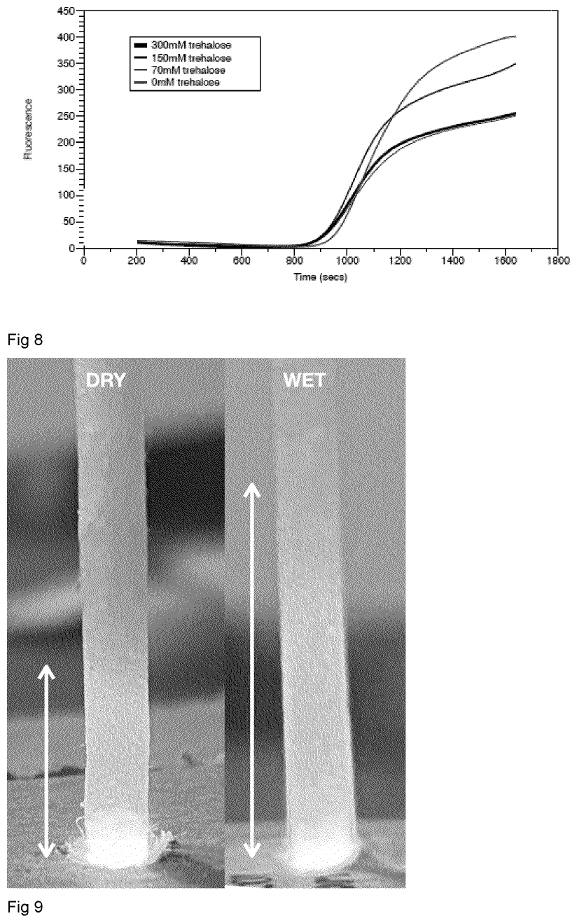

One consideration when dehydrating or lyophilising reagents is the need to potentially include protective reagents to prevent or reduce thermal enzyme denaturation. Sugar excipients are often used in both methods to protect proteins such as enzymes; in particular trehalose is used by yeasts and insects to provide thermal protection and prevent protein damage by extreme temperatures, by replacing water molecules surrounding proteins. Trehalose in combination with other sugars have been used widely in the industry to provide room temperature stable enzymes for diagnostics. Other disaccharides have previously been shown to have similar characteristics. To ensure that inclusion of such sugars did not affect the proposed nucleic acid amplification and diagnostic assays, test samples were run. FIG. 8 shows the effect of different concentrations of trehalose on performance of a test RT-LAMP amplification. The graph shows that trehalose does not inhibit RT-LAMP even at high (300 mM, 10% v/v) concentrations, and that 10 PFU/mL of test sample is detectable within 1200 seconds at this concentration. We believe that concentrations of 70 mM, 150 mM, 300 mM, and 500 mM (15% v/v) should all be feasible to use, and that this may include trehalose alone or in combination with one or more other sugars. High molecular weight sugars such as dextran are particularly useful in addition to disaccharides.

Other data (not shown) using pH colour indicators within the wick (ie, incorporated into the reaction mix) to confirm that amplification takes place shows that a visual indication of colour change is clearly apparent in the wicks after 20 minutes of RT-LAMP carried out on 10 PFU/mL of test sample.

Another potential advantage comes from the unexpected observation that the fibres (particularly polyethylene fibres) in the matrix may act as optical guides to channel and direct fluorescence from a signal after amplification and detection. When tested, unexpectedly there was very good optical coupling with the wick fibre matrix, which enabled good fluorescence measurement with an optical reader. Without wishing to be bound by theory, it is proposed that the high trehalose/sugar content may help with refractive index matching of the filter fibres enabling the photometer to interrogate/measure light from a greater proportion or from the whole of the reaction mixture.

See also FIG. 9, which compares fluorescence in wet and dry wicks showing that light is channelled to an end. Incorporation of additional sugars may potentially be used to modulate refractive index and further improve transmission, if desired.

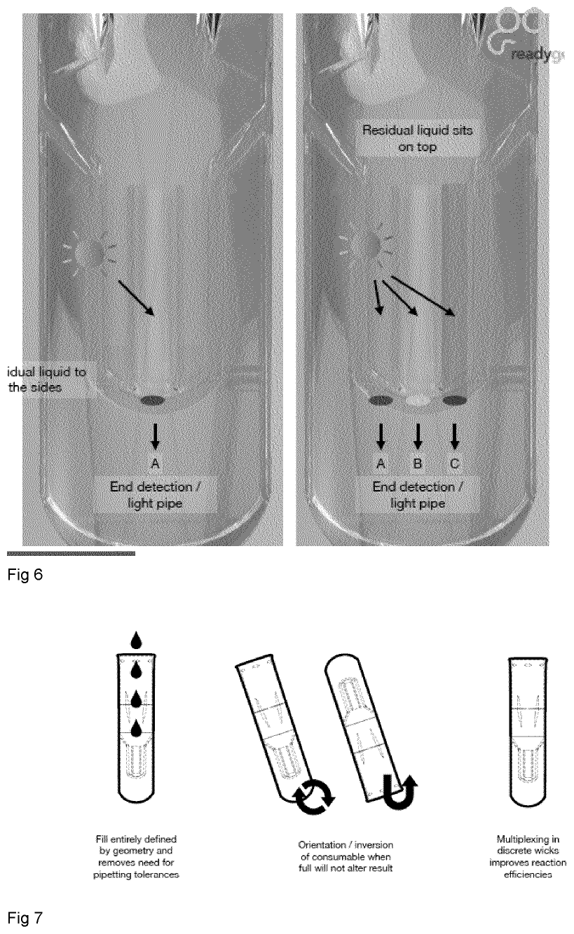

This observation suggests potential configurations of wicks included within a plastic holder or container. See FIG. 6 for an example. In this figure, single or multiple wicks each with a different fluorophore in the reaction mix are placed in adjacent apertures in a plastic holder. As sample is added to saturate the wick, residual sample liquid may accumulate either to the side of a single wick, or on top of multiple wicks if these fill the sample holder. As the amplification reaction is run, fluorescent signal will be channelled along the wick to exit at the cut faces; this can then be detected using a photometer or other optical reader. This arrangement allows separation of multiplex reactions into separate distinct reactions by physical separation, and permits a single optical detector to interrogate the multiple reactions. And again, the predetermined volume of sample and reagents taken up by the wicks removes the need for accurate liquid handling by the user.

Another advantage from placing the wick in a plastic holder is that, because sample is absorbed by capillary action into the wick, then the orientation of the holder is less important, and rotation or inversion of the holder and wick will not affect the result. See FIG. 7.

Further, the diffusional rates along the length of the wick are slow in comparison to the reaction rates. Therefore, excess sample can sit above the wick without interfering with the reaction within the wick.

Additional testing and development revealed benefits as to reaction kinetics from the wick format. Since reagents are thinly coated on the individual fibres and re-suspend rapidly and uniformly, this provides an intrinsic uniformity of the reagent distribution through the sample on rehydration, and no mixing or agitation is required. The capillary structure may provide a micro-environment improving kinetics or efficiency involving local crowding agents (eg trehalose, etc), and the short distance between fibres ensures that diffusion distances to target molecules are short, accelerating reaction time and also ensuring comprehensive access to the sample. Testing demonstrated that wicks provided strong fluorescence signals, and there was a significant (300 second) improvement in time to positivity (TTP) in dried wicks compared with conventional wet test tube reactions. This was confirmed with RPA (recombinase polymerase amplification) as well as RT-LAMP. High concentrations of sugar based cosolvents, (e.g., dextran, trehalose, sucrose, sorbitol, and glycerol) may be used to mimic the macromolecular crowding environment.

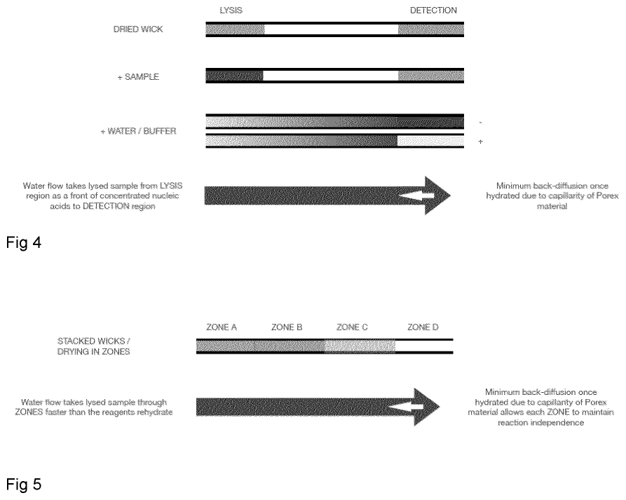

The construction and production methods for the wicks described herein also lend themselves to generation of wicks having discrete “zones” for different parts of the amplification/detection process. For example, FIG. 4 shows a single wick which has lysis reagents incorporated at a first end, and detection reagents at a second end, with the wicks being cut to an appropriate size to include both zones. Although a more complicated manufacturing process—given the need to introduce two different reaction mixes—the end use of the wick may be simplified as sample can be flowed through the wick from the lysis end to the detection end. In a variation, lysis may take place in a central section, and the first, sampling end may be untreated so that it is inert with respect to the sample.

This works because the diffusion rates through the capillary structure end to end are much slower than the reaction kinetics of the events that happen in each zone.

Alternatively, multiple individual wicks each having a different reaction chemistry included can be stacked and joined together, as shown in FIG. 5, to allow for sequential processing of a single sample in multiple different ways as it passes through the multiple wicks.

A related arrangement is shown in FIG. 3; here instead of multiple individual wicks, two crimped sections remain joined, with the first section being dedicated to lysis and the second to detection. If reagents are dried into the wick after crimping (rather than before) then the crimp will prevent reagent flow through during manufacture, potentially simplifying the process of preparing multiple zones. Sample can be pushed or pulled through the wicks—for example, by placing the wick in the barrel of a pipette—such that the liquid bypasses the crimp by leaving and reentering the wick.

1. A process for producing a sampling device for use in analysis of biological samples, the process comprising:
a) providing a porous matrix having a regular cross section and a generally elongate form;
b) contacting the matrix with a liquid reaction mix, such that the reaction mix is adsorbed into the matrix;
c) drying the adsorbed liquid reaction mix, to provide a porous matrix having dried reaction mix therein; and
d) dividing the porous matrix into one or more sections of predetermined length;
to thereby provide said sampling device.

2. The process of claim 1, wherein the step of dividing the porous matrix into sections comprises cutting the porous matrix into individual sections.

3. The process of claim 1, wherein the sections of the porous matrix remain physically connected after dividing, but are not fluidically connected.

4. The process of claim 1, wherein the porous matrix is a fibrous matrix, comprising a plurality of bonded fibres which define voids therebetween.

5. (canceled)

6. (canceled)

7. (canceled)

8. The process of claim 4, wherein the fibrous matrix comprises a polyethylene core and a polypropylene sheath.

9. The process of claim 1, wherein the reaction mix is suitable for performing a nucleic acid amplification based assay.

10. The process of claim 1, wherein the reaction mix comprises a cryoprotective sugar to protect proteins against effects of drying.

11. (canceled)

12. (canceled)

13. The process of claim 1, wherein the step of contacting the porous matrix with the liquid reaction mix comprises immersing a portion of the matrix in the reaction mix.

14. The process of claim 1, wherein the step of contacting the porous matrix with the liquid reaction mix comprises spraying a portion of the matrix with the reaction mix.

15. The process of claim 1, wherein the method comprises allowing the porous matrix to become saturated with the liquid mix prior to drying.

16. (canceled)

17. (canceled)

18. A sampling device for analysis of biological samples, the device comprising a section of porous matrix having a regular cross section and a generally elongate form, the matrix comprising a dried reaction mix therein, the reaction mix comprising reagents for analysis of a biological sample.

19. The sampling device of claim 18 comprising a plurality of said sections which are fluidically separated.

20. The sampling device of claim 18 comprising a plurality of said sections which are fluidically connected.

21. (canceled)

22. The sampling device of claim 18 wherein the matrix is a fibrous matrix, comprising a plurality of bonded fibres which define voids therebetween.

23. The sampling device of claim 18 wherein the reaction mix is suitable for a nucleic acid amplification based assay.

24. The sampling device of claim 18 wherein the reaction mix further comprises a cryoprotective sugar to protect proteins against effects of drying.

25. (canceled)

26. (canceled)

27. The sampling device of claim 18 wherein the porous matrix acts as an optical guide to channel and direct visual signal from a reaction. 28 (Currently Amended) The sampling device of claim 27, wherein the device comprises a sugar, preferably trehalose, which matches the refractive index of the porous matrix.

29. The sampling device of claim 18 wherein the porous matrix comprises one or more crowding agents to improve local reaction kinetics.

30. The sampling device of claim 18, wherein the device comprises a plurality of reaction zones, each of which comprises a different dried reaction mix therein.

31. (canceled)
